(19) United States
(12) Patent Application Publication
(10) Pub. No.: US 2010/0076587 A1
(43) Pub. Date: Mar. 25, 2010

(54) METHOD OF PRODUCING A DISPLAY ITEM OF METALWORK

(76) Inventor: John David Rowley, Hertfordshire (GB)

Correspondence Address: Chad M. Hinrichs;Gable Gotwals, 10th Floor, 100 W. 5th Street, Tulsa, OK, 74103, US

(21) Appl. No.: 12/563,725

(22) Filed: Sep. 21, 2009

(30) Foreign Application Priority Data
Sep. 22, 2008 (GB) GB0817326.2

(51) Int. Cl. G06F 19/00

(52) U.S. Cl. 700/118; 382/263; 700/166

(57) ABSTRACT

A method of producing a display item of metalwork from sheet metal, the method comprising the steps of obtaining a digital image file containing an image of a subject; filtering the digital image file such that the resulting filtered image has increased contrast and enhanced edge definition; deleting unwanted parts of the filtered image; joining adjacent discrete portions of the filtered image together; manipulating the filtered image such that the minimum line width is greater than a predetermined thickness to form a subsequent image; and cutting the sheet metal in the form of the subsequent image.

### CROSS-REFERENCE TO RELATED APPLICATIONS

This application claims priority to Great Britain Patent Application No. 0817326.2, filed Sep. 22, 2008.

### BACKGROUND OF THE INVENTION

The present invention relates to a method of producing a display item of metalwork from sheet metal.

The production of decorative items of metalwork (or metal artwork as it is sometimes called) from photographs is known in the art. For example, companies already exist which offer to design and manufacture weathervanes and signs based on photographs or drawings provided by the customer. Such weathervanes are typically produced by one of two methods.

The first method involves a craftsman or blacksmith handcrafting the item of metalwork usually from wrought iron based on his/her interpretation of the photograph/drawing supplied by the customer. The second method involves editing a digital version of the customer's photograph/drawing and using CAD/CAM (Computer Aided Design/Computer Aided Manufacturing) software to generate code which will direct the motion of a machine tool, such as a laser cutting machine, to cut the exact shape of the edited image. This application relates to this second method.

An example of a UK company which uses the second method is Flairmet Limited (http://www.weathervane.uk.com/acatalog/WEATHERVANES_Options_{—}13.html#aMy_{—}20Image). This company offers to produce metal shapes for the top of weathervanes based on digital images supplied by the customer.

However, the method used by this, and other companies offering a similar service, only involves basic editing of the image supplied and, as such, is used primarily to produce relatively simple shapes in metal such as the outline or silhouette of the main subject of the photograph/drawing.

### BRIEF DESCRIPTION OF THE INVENTION

According to the present invention there is provided a method of producing a display item of metalwork from sheet metal, the method comprising the steps of:

(a) obtaining a digital image file containing an image of a subject;

(b) filtering the digital image file such that the resulting filtered image has increased contrast and enhanced edge definition;

(c) deleting unwanted parts of the filtered image;

(d) joining adjacent discrete portions of the filtered image together;

(e) manipulating the filtered image such that the minimum line width is greater than a predetermined thickness to form a subsequent image; and

(f) cutting the sheet metal in the form of the subsequent image.

Steps (c) to (e) can be carried out in any order or can be carried out simultaneously.

The invention provides a method of producing more detailed images, which are more like line drawings than simple silhouettes, in sheet metal. As a result, more desirable, striking, pieces of metalwork can be produced than before.

By ensuring that the line width of all parts of the image is greater than a predetermined thickness and that adjacent discrete portions of the image are joined together, an image which is suitable for being laser or plasma cut out of sheet metal is provided and a robust piece of metal work, which is unlikely to break during manufacture, transport or use, is produced.

The digital image file may contain an image of a subject and a background. If so, the method may further comprise the step of removing the background from the subject prior to passing the digital image file through the software filter.

Preferably, step (d) involves joining all discrete portions of the image together such that the resulting item of metalwork is a single piece. Alternatively, a single image may be reproduced in two or more pieces which are displayed adjacent to one another.

Filtering step (b) may utilise a software filter which converts a photographic image into an image which represents a line drawing.

The predetermined thickness is preferably at least 20%, more preferably at least 30% and most preferably at least 40% of the thickness of the sheet metal.

Preferably, the method further comprises the step of attaching one or more spacers to the back of the item of metalwork for mounting the item on a surface. By mounting the item in this way and directing light onto it, a desirable shadow effect is created.

The step of cutting the sheet metal in the form of the subsequent image may be an automated process.

The step of cutting the sheet metal in the form of the subsequent image may involve using a laser or plasma cutter.

The automated process is preferably a Computer Aided Manufacturing (CAM) process.

### BRIEF DESCRIPTION OF THE DRAWINGS

An example of a method in accordance with the present invention will now be described with reference to the accompanying drawings, in which:

FIG. 1 is a digital photographic image in “greyscale” containing a subject of three people to be reproduced as an item of metalwork;

FIG. 2 is the photographic image of FIG. 1 with the brightness and contrast adjusted;

FIG. 3 is the photographic image of FIG. 2 with the background cut away leaving just the subject;

FIG. 4 is the photographic image of FIG. 3 after having been passed through a software filter;

FIG. 5 is the image of FIG. 4 after unwanted parts have been deleted, adjacent discrete portions have been joined, line thicknesses have been checked and the resulting image has been vectorized;

FIG. 6 is the image of FIG. 5 converted into a DWG file; and

FIG. 7 is a perspective view of the finished item of metalwork with spacers welded onto the back of it.

### DETAILED DESCRIPTION OF THE PREFERRED EMBODIMENT

The first step in the method involves obtaining a digital photographic image or other digital image and storing it on a computer as a digital image file. This can be done by downloading a digital image from a digital camera, scanning an image using a scanner or by any other suitable means. The digital image file can be in any digital image file format, for example JPEG, GIF or TIFF, provided it can be opened and manipulated in an image editing software program. An example of a suitable image editing program is Adobe™ Photoshop™.

The second step in the method involves opening the digital image file in the image editing program so that the digital image may be viewed and edited.

Steps three to seven which follow all involve using features and tools integrated into the image editing program.

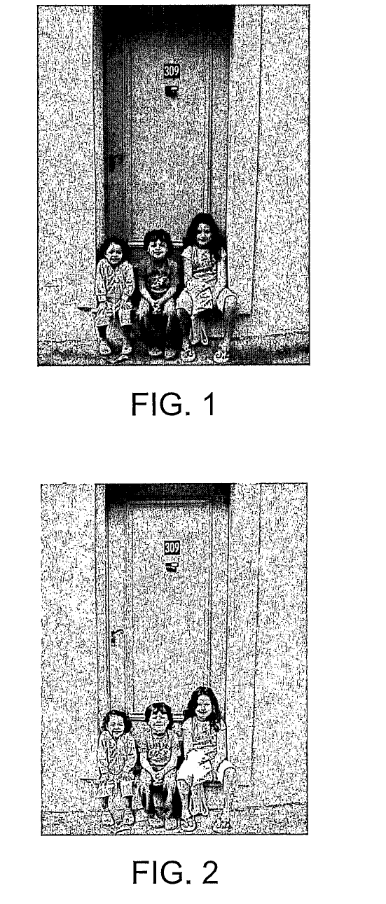

The third step involves using the image editing program to convert the image to black and white or “greyscale”. FIG. 1 shows a digital photographic image which has gone through this process. Clearly if the image is already in black and white there is no need to complete this step.

The example shown in FIGS. 1 to 8 is based on a photographic image of several people. However, it will be appreciated that the invention is not limited to reproducing metal images of people.

The fourth step involves adjusting the contrast of the image to a high level and the brightness of the image to a medium to high level. FIG. 2 shows the photographic image of FIG. 1 after this step has been carried out.

The subject of the image is defined as the part of the image that will form the basis of the image to be cut out of metal. The background of the image is defined as the rest of the image i.e. the part of the image that is not the subject.

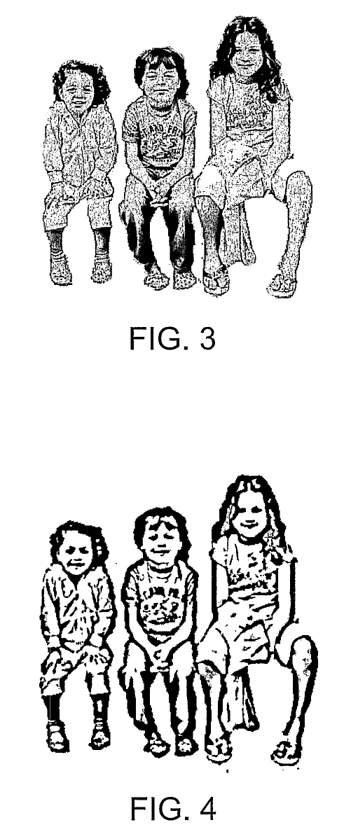

The fifth step is performed by identifying the subject of the image and using the appropriate tools in the image editing program to cut away the background. The outcome of this step is a black and white cut out of the subject of the image against a white background as shown in FIG. 3. In this example the subject of the image is the photographic image of three people.

The sixth step involves passing the image of the subject through one or more software filters which are designed to convert photographic images into images which resemble line drawings. Such filters are available in most image editing programs. The Photoshop™ filter effects “photocopy” and “stamp” have been found to be effective for this purpose. FIG. 4 shows the image which results when the Photoshop™ filter effect “photocopy” is applied to the image of FIG. 3. As can be seen, the image of FIG. 4 has increased contrast and enhanced edge definition compared to the image of FIG. 3.

The seventh step of the method involves using the tools available in the image editing program to ‘clean up’ the image resulting from the filtering step (hereafter referred to as the filtered image) and edit it so that it is suitable for being cut out of sheet metal using a laser or plasma cutter. This step can be divided into three main stages as follows:

1. Zooming in on each part of the filtered image (to a degree that the individual pixels of the image can be seen) and deleting features or parts of the image that are unwanted or not suitable for being cut out of sheet metal. Examples of unwanted parts include blurred areas or small discrete parts which do not have sharp edge definition. Such areas/parts can be seen in the filtered image of FIG. 4.

2. Joining adjacent discrete portions of the filtered image together. Discrete portions are defined here as isolated or ‘floating’ lines/parts of the image which are not attached to any other parts of the image. The image must not contain any discrete portions otherwise pieces of the final item of metalwork corresponding to these parts will break off during manufacture when the image is cut out of sheet metal. In other words, all parts of the image have to be attached so that the final piece of metalwork is made up of a single piece or a small number of separate pieces which can be displayed adjacent to one another. In the case of a small number of pieces, each is processed in the manner set out below.

3. Checking the width of the lines/parts which make up the filtered image and building up parts which have a line width which is less than a certain predetermined value. This is to ensure that the final item of metalwork is robust. The predetermined value is dependent on a number of factors including the type of material used, the thickness of the material and the type of cutting process used. When laser cutting images out of steel plate, the minimum line width, to ensure that the item of metalwork is robust in use, is preferably at least 20%, more preferably at least 30% and most preferably at least 40% of the thickness of the steel plate.

The eighth step involves converting the image resulting from the seventh step (the subsequent image), which is composed of an array of pixels, into a vector based image which is composed of lines and curves which have smooth edges. This process, which is known as vectorizing, is carried out using a vector based graphics program such as Adobe™ Fireworks™. The process results in a sharper image which can be scaled to any size without losing clarity or resolution. The vector based image is saved as a PDF file.

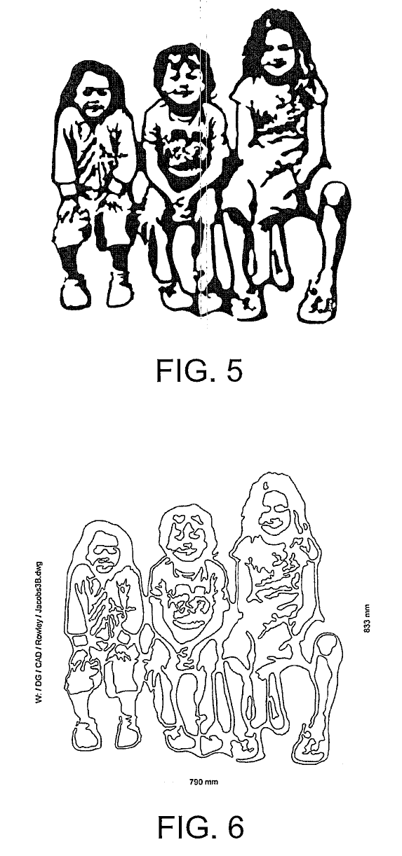

FIG. 5 shows the image of FIG. 4 after steps seven and eight have been completed. This image corresponds to the image of the final display item of metalwork.

The ninth step involves converting the vectorized PDF digital image file into a DWG or DXF drawing file using a software program such as AutoDWG™ PDF to DWG converter. This file can then be edited in a CAD package such as AutoCAD™ to create a 3D CAD model of the image to be cut out of sheet metal. FIG. 6 shows the image of FIG. 5 after it has been converted into a DWG drawing file.

The tenth step involves using a Computer Aided Manufacturing (CAM) program, which may be integrated into the CAD program, to generate code (typically CNC code) from the 3D CAD model. This code is then used to drive a numerically controlled laser or plasma cutter which cuts out the exact shape of the image from a sheet of mild steel of appropriate thickness and standard. A sheet of stainless steel, aluminium or any other suitable metal can also be used depending on the end user's preference.

The eleventh step involves sandblasting the mild steel image cut out of the mild steel sheet to clean up any rough edges.

The twelfth step involves welding an appropriate number of steel pins to the back of the mild steel image. These pins act as spacers when the mild steel image is mounted on a wall or other surface. The space created between the image and the wall enables a shadow of the image to be cast on the wall when light is directed on it. Pins of approximately 6 inches have been found to produce a desirable shadow effect. An appropriate number of pins should be used to ensure that the image is securely mounted on the wall. In most cases, four pins have been found to be sufficient.

The thirteenth and final step involves painting the finished mild steel image according to the preference of the end user. If the image is produced in another metal, various other finishes can be chosen including polished or brushed finishes.

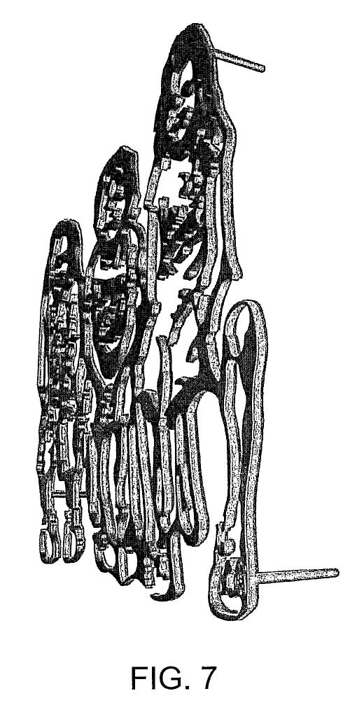

FIG. 7 shows the finished mild steel image developed from the DWG drawing image of FIG. 6. The image has been painted and has had several steel pins welded on to its back surface as can be seen. When the image is mounted on a flat surface, such as a wall, and lit, a desirable shadow effect is cast on the wall.

What is claimed:

1. A method of producing a display item of metalwork from sheet metal having a given thickness, said method comprising the steps of:
obtaining a digital image file containing an image of a subject;
filtering the digital image file such that the resulting filtered image has increased contrast and enhanced edge definition;
deleting unwanted parts of the filtered image;
joining adjacent discrete portions of the filtered image together;
manipulating the filtered image such that the minimum line width is greater than a predetermined thickness to form a subsequent image; and
cutting the sheet metal in the form of the subsequent image.

2. A method according to claim 1, further comprising the step of removing background from the image.

3. A method according to claim 1, said metalwork comprising a single piece of metal.

4. A method according to claim 1, said filtering step comprising utilising a software filter to convert a photographic image into a line drawing.

5. A method according to claim 1, said predetermined thickness comprising a thickness greater than 20% of the thickness of the sheet metal.

6. A method according to claim 1, said predetermined thickness comprising a thickness greater than 30% of the thickness of the sheet metal.

7. A method according to claim 1, said predetermined thickness comprising a thickness greater than 40% of the thickness of the sheet metal.

8. A method according to claim 1, further comprising attaching one or more spacers to a back surface of the item of metalwork for mounting the item on a surface.

9. A method according to claim 1, said step of cutting the sheet metal in the form of the subsequent image further comprising an automated process.

10. A method according to claim 1, said step of cutting the sheet metal in the form of the subsequent image further comprising using a laser cutter.

11. A method according to claim 9, said automated process further comprising a Computer Aided Manufacturing process.

12. A method according to claim 1, said step of cutting the sheet metal in the form of the subsequent image further comprising using a plasma cutter.
